(19) United States
(12) Patent Application Publication
(10) Pub. No.: US 2026/0222014 A1
(43) Pub. Date: Jul. 30, 2026

(54) SYSTEM AND METHOD FOR RIS-ASSISTED ENVIRONMENTAL IMPAIRMENT-AWARE ROBUST COST-EFFICIENT FIWI NETWORK PLANNING.

(71) Applicant: INDIAN INSTITUTE OF TECHNOLOGY KHARAGPUR, Kharagpur (IN)

(72) Inventors: Nilesh Chatur, Kharagpur (IN); Tushar Bose, Kharagpur (IN); Aneek Adhya, Kharagpur (IN)

(73) Assignee: INDIAN INSTITUTE OF TECHNOLOGY KHARAGPUR, Kharagpur, WB (IN)

(21) Appl. No.: 19/072,813

(22) Filed: Mar. 6, 2025

(30) Foreign Application Priority Data
Jan. 25, 2025 (IN) 202531006303

(51) Int. Cl. H04B 7/04; H04W 16/26; H04W 24/04

(52) U.S. Cl. CPC H04B 7/04013; H04W 16/26; H04W 24/04

(57) ABSTRACT

The invention provides a system for Reconfigurable Intelligent Surfaces (RIS) assisted environmental impairment-aware robust cost-efficient Fiber-Wireless (FiWi) network planning and upgradation which mitigates signal loss caused by the environmental impairments including rain attenuation. The system comprises at least one prediction module, at least one outage computation module, and at least one RIS placement module. The prediction module forecasts the environmental impairments that degrade the signal quality. The outage computation module is fed with output of the prediction module to identify the outage regions based on environmental conditions and channel impairments. The outage computation module analyzes user locations and channel conditions including Signal-to-Interference-plus-Noise Ratio (SINR) to detect users in the outage regions. The RIS placement module is configured to execute convex hull-based RIS placement determination based on the identified outage regions and the users located therein for dynamically determining candidate locations for the RIS deployment and optimizing the RIS placement for reflecting and amplifying the signals to serve outage users efficiently addressing coverage gaps.

### RELATED APPLICATIONS

This application claims priority to India Patent Application No. 202531006303, Filing Date Jan. 25, 2025, entitled SYSTEM AND METHOD FOR RIS-ASSISTED ENVIRONMENTAL IMPAIRMENT-AWARE ROBUST COST-EFFICIENT FIWI NETWORK PLANNING; which is incorporated herein by reference in its entirety.

### FIELD OF THE INVENTION

The present invention relates to Fiber-Wireless (FiWi) access network. More specifically, the present invention is directed to provide a system for planning and upgradation of FiWi networks, integrating Fixed Wireless Access (FWA) and Fiber-to-the-Home (FTTH) technologies with active Reconfigurable Intelligent Surfaces (RIS). Utilizing the RIS, the present system addresses environmental impairments, such as rain. The proposed system includes functional modules such as Prediction, Outage Computation, and RIS Placement, that may be deployed at Base Stations (BS), edge servers, or cloud servers associated with the network. The system leverages these functional modules, e.g., the Prediction Module is used for forecasting environmental impairments, the Outage Computation Module is used for identifying outage, and the RIS Placement Module is used for optimizing RIS deployment. These functional modules collaboratively address challenges like rain losses in mmWave communication and ensures robust connectivity, reduced CapEx, and scalability, making it suitable for both new (greenfield) network deployments and upgradation of existing networks in 5G and beyond.

### BACKGROUND OF THE INVENTION

The need for a Fiber-Wireless (FiWi) access network arises from the desire to combine the strengths of Fixed Wireless Access (FWA) and Fiber-to-the-Home (FTTH) technologies while mitigating their weaknesses. By integrating fiber and wireless technologies, FiWi access networks offer a comprehensive solution that addresses diverse connectivity requirements, geographical challenges, and environmental impairments, such as rain that affect mmWave signal propagation.

In wireless networks, the number of users that can be connected with next-generation NodeBs (gNBs) is constrained by the availability of Resource Blocks (RBs) and beams generated at gNBs, the channel conditions experienced by users, and their data rate demands. Conversely, the number of users connected via fiber is limited by the splitting ratio of power splitters, the line rate of the fiber, and the data rate demands of users. While wireless connectivity is often preferred for its cost efficiency when both FWA and FTTH meet the Quality of Service (QoS) criteria, resource constraints such as the number of RBs, beams, transmission power at gNBs, and environmental impairments can limit the ability to serve all users through wireless mode alone. This necessitates optimal identification of network architecture and connection modes (fiber/wireless) for each user to ensure reliable connectivity. Inefficient FiWi network deployment leads to degraded QoS and increased Capital Expenditure (CapEx).

The prevailing state of the art in mmWave communication and Fiber-Wireless (FiWi) networks involves the use of distributed Intelligent Reflecting Surfaces (IRS) and advanced beamforming techniques to enhance coverage and signal quality. While these approaches improve line-of-sight (LoS) communication and reduce blockage effects, they often fail to account for environmental impairments like rain, which are significant challenges in real-world deployments.

In TDM-PON and LTE-A Based Cost-Efficient FiWi Access Network Deployment, IEEE Communications Letters, vol. 26, no. 11, pp. 2685-2689, November 2022, doi: 10.1109/LCOMM.2022.3198516, the inventors have explored cost-efficient network deployment strategy for TDM-PON and LTE-A-based FiWi network. It proposes an optimization framework, that iteratively finds out the optical and wireless resource allocation while minimizing the CapEx and ensuring QoS for users.

In Planning Cost-Efficient FiWi Access Network With Joint Deployment of FWA and FTTH, IEEE Transactions on Communications, vol. 72, no. 9, pp. 5688-5703, September 2024, doi:10.1109/TCOMM.2024.3384933, the inventors have explored cost-efficient FiWi access network deployment with joint utilization 5G FWA and TDM-PON network. It utilizes the 3D beamforming and sectorised approach to minimize the co sector interference. It also utilizes the 3D resource grid for efficient resource allocation. Finaly, propose an optimization framework, that minimizing the CapEx and while ensuring QoS for users.

Coverage Enhancement in Millimeter-Wave Cellular Networks via Distributed IRSs, IEEE Transactions on Communications, vol. 71, no. 2, pp. 1153-1167, February 2023, doi: 10.1109/TCOMM.2022.3228298 leverages distributed intelligent reflecting surfaces (IRSs) to enhance coverage probability in mmWave cellular networks. By deploying multiple IRSs modeled as a binomial point process around the base station, this approach increases the likelihood that users fall within the reflection directions of the IRSs. Although this strategy improves coverage by ensuring line-of-sight (LoS) links for blocked paths, it relies on distributed IRS deployment without addressing optimal placement strategies for serving clustered users effectively.

Joint Base Station and IRS Deployment for Enhancing Network Coverage: A Graph-Based Modeling and Optimization Approach, IEEE Transactions on Wireless Communications, vol. 22, no. 11, pp. 8200-8213, November 2023, doi: 10.1109/TWC.2023.3260805 focuses on optimizing the deployment of BSs and IRSs to enhance network coverage through cascaded LoS paths but does not consider the impact of environmental impairments, such as rain, on communication links or the resulting outages.

U.S. Pat. No. 11,489,559B2 discloses about scheduling multi-user MIMO transmissions in fixed wireless access systems where topology optimization is not considered. However, with high user density providing the simultaneous wireless connection becomes infeasible and may cause service interruption at the users owing to the exhaustion of the time-frequency resource over the beams.

US20230283982A1 discloses about service area determination in a telecommunications network where the effective service polygon is determined in which a particular service offered by a communication network is available. This embodiment does not consider a plurality of the important factors such as cost optimization and resource allocation.

US20230208486A1 discloses about RIS-assisted communication networks which addresses network capacity enhancement and adaptability to changing channel conditions through an irregular surface-based adaptive beamforming design scheme. However, these approaches consider large-scale and small-scale fading effects but fail to account for environmental impairments, such as rain, and the resulting signal degradation and outages. Additionally, prior art overlooks the critical aspect of optimal RIS placement, which significantly impacts the overall system performance.

US20230327714A1 explore mechanisms for identifying, setting up, signaling, controlling, and enabling communication within a network using one or more controllable RIS, base stations, and user equipment (UE). However, these approaches overlook the impact of environmental losses, such as rain attenuation, on the signaling, setup, and control mechanisms for RIS-assisted communication between base stations and users.

Existing solutions primarily focus on deploying IRS in distributed configurations, which can be resource-intensive and lack an optimization framework for effective placement. Additionally, these methods do not fully integrate the strengths of Fixed Wireless Access (FWA) and Fiber-to-the-Home (FTTH) technologies to address connectivity issues holistically. The absence of a comprehensive impairment-aware strategy for network planning results in suboptimal performance and increased infrastructure costs.

It is thus there has been a need for a new technique which can address these gaps by proposing an environmental impairment-aware framework that integrates Reconfigurable Intelligent Surfaces (RIS) with FiWi networks. The need was not only mitigates environmental losses but also employs a cost-efficient and robust optimization model for RIS placement.

### OBJECT OF THE INVENTION

The basic object of the present invention is to provide method and system for implementing RIS-assisted Environmental Impairment-aware (such as rain) Robust Cost-efficient FiWi Network planning as well as upgrading the same with convex hull-based RIS placement methodology that will dynamically determine optimal locations for RIS deployment, ensuring minimal infrastructure requirements and enabling seamless network upgradation in a cost-effective manner.

Another object of the present invention is to provide a unified hybrid architecture for FiWi networks including a unique system involving FWA technology (gNB, CPE), FTTH technology (OLT, ONU, passive splitter), and RIS and supported by functional modules (viz., Prediction, Outage Computation, and RIS Placement Modules) to enhance resource allocation, coverage, and adaptability for network planning and upgradation.

### SUMMARY OF THE INVENTION

Thus, according to the basic aspect of the present invention there is provided a system for Reconfigurable Intelligent Surfaces (RIS) assisted environmental impairment-aware robust cost-efficient Fiber-Wireless (FiWi) network planning and upgradation which mitigates signal loss caused by the environmental impairments including rain attenuation, wherein the said system comprises
at least one prediction module to forecast the environmental impairments that degrade the signal quality;
at least one outage computation module fed with output of the prediction module to identify the outage regions based on environmental conditions and channel impairments, wherein said outage computation module analyzes user locations and channel conditions including Signal-to-Interference-plus-Noise Ratio (SINR) to detect users in the outage regions; and
at least one RIS placement module which is configured to execute convex hull-based RIS placement determination based on the identified outage regions and the users located therein for dynamically determining candidate locations for the RIS deployment and optimizing the RIS placement for reflecting and amplifying the signals to serve outage users efficiently addressing coverage gaps.

In the above system, the outage computation module considers user-specific requirements, including data rate demands and geographical distribution, to identify weak coverage areas and the outage regions.

In the above system, the modules are scalable and deployed at various levels of the network, including Base Station (BS), edge servers, or cloud servers, depending on processing requirements and deployment scenario.

In the above system, the modules are implemented in computing and storage infrastructure on the network hardware.

In the above system, the FiWi network based on a multistage time-division multiplexing passive optical network (TDM-PON) having power splitter (PS) stages alongside gNBs includes
an Optical Line Terminal (OLT) located at central office;
a primary power splitter (PPS) connected to said OLT;
multiple secondary power splitters (SPSs) connected to the PPS for distributing optical signal further across the network;
at least an Optical Network Unit (ONU) at user end to serve an FTTH user, providing the user with fiber-based connectivity, and also optionally connected to the gNB through a hybrid module (ONU-gNB), allowing the ONU to provide backhaul for wireless services and serving as FWA users, whereby the FWA users are served through a Customer Premises Equipment (CPE) installed at the wireless user's location; and
said active RIS which are selectively deployed to enhance coverage of the wireless services by reflecting and amplifying the signals to the outage users for mitigating signal loss caused by the environmental impairments and ensures robust connectivity in challenging conditions.

According a further aspect in the present invention there is provided a method for Reconfigurable Intelligent Surfaces (RIS) assisted environmental impairment-aware robust cost-efficient Fiber-Wireless (FiWi) network planning and upgradation which mitigates signal loss caused by the environmental impairments, wherein the said method comprises the steps of
receiving essential network related inputs, including user distribution, maximum number of gNBs that can be deployed, and network configurations for clustering and initial network planning;
grouping users of the network into clusters and placing at least one of the gNBs at centroids of these clusters, such as that the users are assigned to specific gNB sectors based on their geographical location, ensuring balanced load distribution across sectors;
dividing each gNB's coverage area into three non-overlapping sectors of 120°, served by dedicated Uniform Planar Array (UPA), thereby enabling efficient spatial multiplexing through dedicated UPAs;
framing wireless connections of the network through beamforming and channel parameter computation;
optimizing the wireless connections and network scenario without the environmental impairments;
optimizing the wireless connections and network scenario with the environmental impairments;
identifying outage users in the network for the environmental impairments and accordingly determining the candidate locations for RIS to serve the outage users;
optimizing the RIS placement and establishing the connections therewith to serve the outage users efficiently addressing coverage gaps for the the environmental impairments.

In the above method, the grouping users of the network into clusters is validated by Calinski-Harabasz (CH) criterion to ensure an efficient initial network layout that minimizes interference and maximizes coverage.

In the above method, the framing of the wireless connections builds foundational parameters for SINR and resource block computation and it includes
computing beamforming vectors (W_{c}^{Nb}) for each gNB sector, generating N_{b} simultaneous beams to enhance spatial multiplexing, whereby directional gain (G(θ, φ)) of the related UPA is calculated to optimize signal strength within each 120° sector;
calculating large-scale (path loss) and small-scale (multipath fading) channel parameters for signal frequencies preferably mm-Wave frequencies, whereby the gNB-user channel matrix (h_{gu}) is derived to quantify the quality of the link between the gNB and users.

In the above method, the optimization of the wireless connections and network scenario without the environmental impairments such as Rain Losses includes
computing SINR (Γ) using channel parameters (h_{gu}), gNB transmitted power, and beamforming gains to assesses the link quality for each user in their assigned sector, whereby based on the SINR, appropriate Modulation and Coding Scheme (MCS) class is selected and further based on the MCS value, the number of Resource blocks (RBs) required to meet the user's data rate is calculated;
involving an Integer Linear Programming (ILP) model which optimizes allocation of fiber and wireless connections for users, minimizing costs and ensuring connectivity, whereby model outputs include the fiber connections (Fᵤᵢ) and the wireless connections (Wᵤᵢ).

In the above method, the optimization of the wireless connections and network scenario with the environmental impairments such as Rain Losses includes
computing adjusted SINR (Γ) values considering environmental losses and further recalculating the MCS class and RB requirements accordingly;
involving ILP model for optimizing the Fiber and wireless connections under these modified conditions, producing outputs \hat{F}ᵤᵢ and Ŵᵤᵢ.

In the above method, the outage users are identified as those users (Oᵤ) who were initially provided with wireless connections in the ILP output computed without considering environmental losses and were subsequently assigned fiber connections in the ILP output when environmental losses (e.g., rain) were included in the optimization process.

In the above method, the determination of the candidate locations for deploying the RIS based on the outage users through convex hull process including
determining the outage users, whereby for each gNB and its sectors, users experiencing outages due to environmental impacts (e.g., rain attenuation) are identified;
computing convex hull, whereby for each sector with outage users, the convex hull that encloses all these users are computed;
identifying candidate locations, whereby vertices of the convex hull are identified as the candidate locations for deploying the RIS;
optimizing the RIS placement, whereby all the gNBs in the network are considered and the ILP is utilized to select the optimal RIS deployment locations from the identified candidate locations, the ILP is modeled to minimize capital expenditure while ensuring the data rate requirements of all users are satisfied.

In the above method, the optimization of the candidate RIS location includes
computing gNB-RIS channel matrix (H_{gr}) and RIS-user channel vector (hᵣᵤ) for each candidate RIS location to characterize indirect paths facilitated by the RIS, enabling SINR enhancements for outage users;

recomputing the SINR (Γ) for each outage user using the gNB-RIS channel matrix (H_{gr}) and the RIS-user channel vector (hᵣᵤ), considering indirect (gNB-RIS-user) paths; recalculating the MCS and the required number of RBs based on the recomputed SINR, they are recalculated.

The above method includes
involving the ILP optimization for the RIS-assisted wireless connections for outage users and replacing the previous ILP model output with environment impact;
reevaluating the users previously assigned with fiber connections under the environment impact and if the outage users are supported by the RIS-assisted wireless connections, these users are transitioned back to wireless connectivity, while existing wireless and fiber connections for non-outage users remain unchanged, maintaining consistency in the broader network design;
applying Minimum Spanning Tree (MST) to finalize the fiber layout, minimizing the trenching and duct cost.

### BRIEF DESCRIPTION OF THE DRAWINGS

FIG. 1: Illustration of the environmental impairment-aware multistage TDM-PON and 5G FWA-based robust FiWi access network architecture.

FIG. 2: Illustration of the block diagram for functional modules of the present system supporting RIS placement, including the Prediction Module, Outage Computation, and RIS Placement. These modules collaboratively identify outage regions and optimize the deployment of Reconfigurable Intelligent Surfaces (RIS) for robust network connectivity

FIG. 3: Flowchart of the Proposed Methodology

FIG. 4: User distribution and network deployment under scenarios without and with rain loss (150 mm/hr). (a) Network planning without loss, showing fiber and wireless connections and deployment of other network devices. (b) Distribution of wireless and fiber-connected users without loss scenario. (c) Increase in fiber connected users due to outage under rain loss. (d) Distribution of outage users across gNBs. (e) Convex hull representation of outage users in gNB sectors. (f) Optimized RIS placement based on convex hull. (g) Complete deployment plan with rain loss and RIS utilization for enhanced coverage.

### DETAILED DESCRIPTION OF THE INVENTION

This invention introduces a holistic framework for Fiber-Wireless (FiWi) network deployment and upgradation, integrating Fixed Wireless Access (FWA) and Fiber-to-the-Home (FTTH) technologies with active Reconfigurable Intelligent Surfaces (RIS). The system addresses key challenges in 5G and beyond networks, particularly environmental impairments such as rain, which degrade mmWave signal quality and coverage. The framework ensures robust connectivity, cost efficiency, and scalability for modern network planning.

The proposed framework provides a system and method that leverages advanced techniques for environmental impairment modeling, RIS placement optimization, and dynamic resource allocation, integrating them into a unified hybrid network infrastructure. By dynamically identifying outage-prone regions and deploying RIS using a convex hull-based algorithm, the system ensures robust and cost-efficient network connectivity while significantly reducing Capital Expenditure (CapEx).

The key contributions of this invention are categorized into two groups:
1. Fiwi System Architecture for a Robust Network:
   The architecture integrates FWA and FTTH technologies, combining their strengths to ensure reliable connectivity and seamless integration.
   It includes key functional modules—Prediction, Outage Computation, and RIS Placement—which are designed to analyze network conditions, forecast impairments, identify outage regions, and optimize resource allocation. These modules can be deployed at the Base Station (BS), edge server, or cloud server, enhancing adaptability and scalability.
2. Methodology for RIS Placement:
   A novel convex hull-based RIS placement algorithm dynamically determines candidate locations for RIS deployment, addressing coverage gaps efficiently.
   The methodology works in conjunction with the modular architecture to forecast environmental impairments, identify outage-prone regions, and execute the RIS placement strategy.
   This approach ensures optimal deployment, robust coverage, and minimal infrastructure costs, making it suitable for both new (greenfield) network deployments and upgrading existing FiWi networks.

By combining a robust FiWi architecture with an innovative RIS placement methodology, this invention provides a scalable, resilient, and cost-efficient solution for the challenges of modern network planning in 5G and beyond. The modular framework not only facilitates robust deployment but also supports future upgrades, ensuring long-term adaptability and network performance under real-world conditions.

### Fiwi Architecture for a Robust Network

FIG. 1(a) illustrates a 5G Fiber-Wireless (FiWi) access network setup incorporating a multistage time-division multiplexing passive optical network (TDM-PON) architecture, featuring two power splitter (PS) stages alongside 5G gNBs. This configuration includes an Optical Line Terminal (OLT) located at the central office, which is connected to a primary power splitter (PPS). Several secondary power splitters (SPSs) are connected to the PPS, distributing the optical signal further across the network. At the customer premises, an Optical Network Unit (ONU) is installed to serve an FTTH user, providing the user with fiber-based connectivity. Alternatively, the ONU can be connected to a gNB through a hybrid module (ONU-gNB), allowing the ONU to provide backhaul for 5G wireless services; this hybrid setup is particularly useful for serving FWA users. The FWA users are served through a Customer Premises Equipment (CPE) installed at the wireless user's location. In areas where users experience outages due to environmental factors like rain, active RISs are deployed to enhance coverage. By reflecting and amplifying the mmWave signals, active RIS helps to mitigate signal loss caused by these environmental impairments. It redirects signals to outage users, ensuring robust connectivity in challenging conditions.

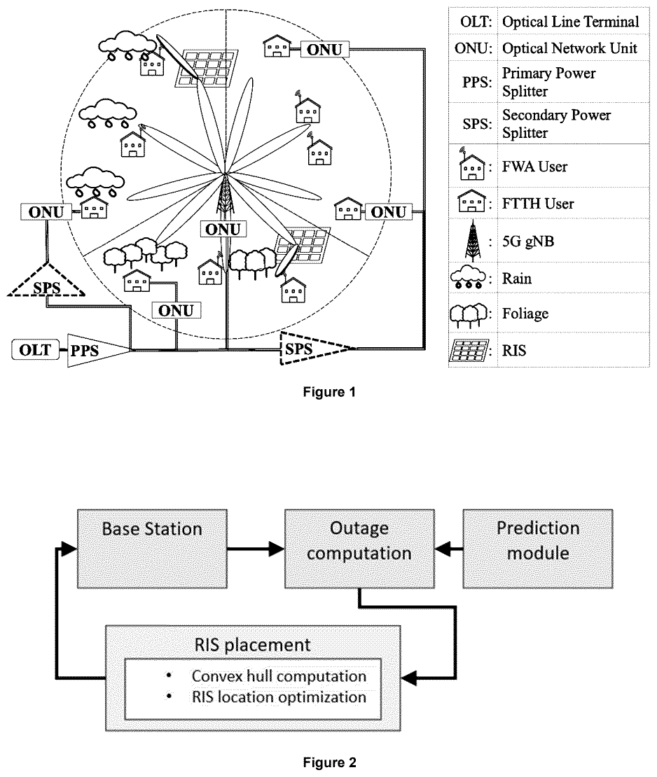

FIG. 2 illustrates the modular flow for the functional blocks necessary to enable RIS placement in the proposed robust FiWi network architecture. The system begins with the Prediction Module, which forecasts environmental impairments, such as rain, that degrade mmWave signal quality. This module helps identify potential outage regions based on environmental conditions and channel impairments.

The output of the Prediction Module feeds into the Outage Computation Module, which analyzes user locations and channel conditions, such as Signal-to-Interference-plus-Noise Ratio (SINR), to detect users in outage regions. This module also considers user-specific requirements, including data rate demands and geographical distribution, to identify weak coverage areas.

Once outage-prone regions are identified, the RIS Placement Module uses a convex hull-based algorithm to determine candidate locations for deploying active RIS. This algorithm optimizes RIS placement by reflecting and amplifying mmWave signals to serve outage users efficiently. The synergy between these modules enables dynamic and optimal RIS placement, ensuring robust coverage and minimizing infrastructure costs. This modular system is scalable and can be deployed at various levels of the network, including the Base Station (BS), edge servers, or cloud servers, depending on the processing requirements and deployment scenario.

### Discussion on Flowchart of the Proposed Methodology

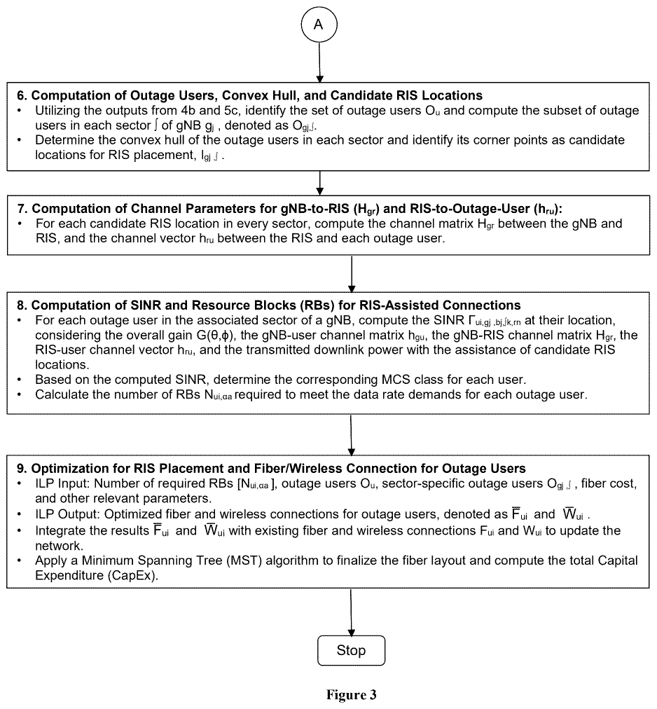

The flowchart in FIG. 3 illustrates a comprehensive methodology for network planning and optimization, integrating modern wireless communication technologies such as beamforming, RIS (Reconfigurable Intelligent Surfaces), and environmental factors like rain losses. The methodology is divided into well-defined steps, ensuring logical progression and efficient optimization. The step-by-step discussion of the flowchart is as follows:

### Step 1. Inputs

The methodology begins with the essential inputs, including user distribution, maximum number of gNBs that can be deployed, and network configurations (i.e., OLT, PPS, and SPS placements and their configurations). These inputs form the basis for clustering and initial network planning. Each gNB's coverage area is divided into three non-overlapping sectors of 120°, served by dedicated Uniform Planar Array (UPA), thereby enabling efficient spatial multiplexing through dedicated UPAs.

### Step 2. User Clustering and gNB Placement

Using the k-means++ algorithm, users are grouped into clusters, and gNBs are placed at the centroids of these clusters. This step ensures optimal gNB placement, reducing interference and balancing load across sectors. The Calinski-Harabasz (CH) criterion validates the clustering process. Users are assigned to specific gNB sectors based on their geographical location, ensuring balanced load distribution across sectors. This stage ensures an efficient initial network layout that minimizes interference and maximizes coverage.

### Step 3. Mathematical Framework for Wireless Connections

3a. Beamforming: Beamforming vectors (W_{c}^{Nb}) are computed for each gNB sector, generating N_{b} simultaneous beams to enhance spatial multiplexing. Directional gain (G(θ, φ)) of the related UPA is calculated to optimize signal strength within each 120° sector.
3b. Channel Parameter Computation: Large-scale (path loss) and small-scale (multipath fading) channel parameters are calculated for mm-Wave frequencies. The gNB-user channel matrix (h_{gu}) is derived to quantify the quality of the direct link between the gNB and users. This stage (3a and 3b) builds the foundational parameters for SINR and resource block computation.

### Step 4. Optimization Without Rain Losses

This Process Evaluates the Network Scenario Without Rain Losses:
4a. SINR and RB Computation: SINR (Γ) is computed using channel parameters (h_{gu}), gNB transmitted power, and beamforming gains. This step assesses the link quality for each user in their assigned sector. Based on the SINR, the appropriate Modulation and Coding Scheme (MCS) class is selected. Moreover, based on the MCS value, the number of Resource blocks (RBs) required to meet the user's data rate is calculated.
4b. ILP Model for Fiber/wireless Connections: An Integer Linear Programming (ILP) model optimizes the allocation of fiber and wireless connections for users, minimizing costs and ensuring connectivity. Outputs include the fiber connections (Fui) and wireless connections (Wᵤᵢ).

### Step 5. Optimization With Rain Losses

This parallel path mirrors step 4 but incorporates environmental factors:
5a. Rain Loss Calculation: Rain losses are integrated into the large-scale channel parameters, capturing their impact on signal quality.
5b. SINR and RB Computation: Adjusted SINR (Γ) values are computed, considering environmental losses. MCS class and RB requirements are recalculated accordingly.
5c. ILP Model: Fiber and wireless connections are optimized under these modified conditions, producing outputs \hat{F}ᵤᵢ and \hat{F}ᵤᵢ.

The parallel computation of steps 4 and 5 enables a comprehensive evaluation of network performance under varying conditions.

### Step 6. Outage User Identification and RIS Candidate Locations

Outage Users Definition: Outage users are identified as those who
Were initially provided with wireless connections in the ILP output of step 4b (computed without considering environmental losses);
Were subsequently assigned fiber connections in step 5c when environmental losses (e.g., rain) were included in the optimization process.

This refined definition highlights users whose connectivity is significantly impacted by environmental factors, necessitating further optimization using RIS.
Outage Identification: Outputs from steps 4b and 5c are analysed to identify outage users (Ou).
Candidate RIS Locations: The proposed convex hull algorithm determines the candidate locations for deploying RIS.

### Step 7. Channel Parameters for RIS-Assisted Links

For each candidate RIS location, the gNB-RIS channel matrix (H_{gr}) and the RIS-user channel vector (hᵣᵤ) are computed. These parameters characterize the indirect paths facilitated by the RIS, enabling SINR enhancements for outage users.

### Step 8. SINR and RB Computation for RIS-Assisted Connections

Using the gNB-RIS channel matrix (H_{gr}) and the RIS-user channel vector (hᵣᵤ), the SINR (Γ) for each outage user is recomputed, considering indirect (gNB-RIS-user) paths.
Based on the recomputed SINR, the MCS and the required Number of RBs are recalculated.

### Step 9. Final Optimization for RIS Placement and Connections

The ILP output of this stage that delineates the RIS utilization and the fiber/wireless connection to the outage users.
1. ILP Optimization
   The ILP optimization includes the RIS-assisted wireless connections for outage users, replacing the output from step 5c.
   Users previously assigned with fiber connections in step 5c are reevaluated. If the users are supported by the RIS-assisted wireless connections, these users are transitioned back to wireless connectivity.
   The ILP ensures a cost-effective combination of RIS placement, wireless connections (W) , and fiber connections (F).
2. Integration With Network Infrastructure
   The final ILP output (i.e., W, F) replaces the ILP results from step 5c for outage users. This ensures that the updated network plan reflects the benefits of RIS deployment.
   Existing wireless and fiber connections for non-outage users from step 5c remain unchanged, maintaining consistency in the broader network design.
3. Apply MST
   The Minimum Spanning Tree (MST) algorithm is applied to finalize the fiber layout, minimizing the trenching and duct cost.

### Final Outputs of the Methodology

The final network plan includes:
Optimized Fiber and Wireless Connections: Outputs Fand Wreflect the inclusion of RIS assisted optimizations, replacing the initial results from step 5c for outage users.
RIS Placement: Optimal RIS deployment ensures minimized outages and improved wireless connectivity.
Cost-Optimized Layout: The MST algorithm ensures the most cost-effective deployment of fiber and wireless resources across the network.

In a preferred embodiment of the present invention, optimized ILP modelling includes
1. Define Parameters and Decision Variables
   a. Parameters: Input data necessary for optimization, such as costs, resource limits, or performance requirements.
   b. Decision Variables: Variables that represent the decisions to be optimized; variables will take binary values.
2. Define the Objective Function: Specify the goal of the optimization problem, such as minimizing cost, or maximizing performance.
3. Define the Constraints: Include logical constraints that the solution must satisfy.
4. Solve the ILP Using Optimization Solver: Use a solver like IBM CPLEX, or open-source tools to solve the optimization problem.
5. Obtain the Output: Analyze the solution provided by the solver, which includes the values of decision variables, the optimized objective value, and any relevant performance metrics.

### Conclusion

This methodology ensures an adaptive, cost-efficient, and resilient network design that effectively addresses the challenges posed by environmental losses and enhances user connectivity with RIS. The methodology concludes with a fully optimized network design that:
Balances connectivity and cost.
Adapts to environmental challenges.
Incorporates RIS technology for improved performance.

This systematic and modular approach ensures scalability, making it suitable for varying network sizes and conditions.

### Results

The proposed invention has been validated through extensive simulations using realistic 3GPP Rural Macro (RMa) scenarios. These simulations incorporate rain impairments, convex hull-based RIS placement, and optimization method to demonstrate the system's performance in mitigating user outages, optimizing resource allocation, and minimizing deployment cost. However, an experimental implementation on testbed, physically using the hardware has not been conducted. The results confirm the feasibility and effectiveness of the methodology in a simulation environment, providing a solid foundation for future experimental validation.

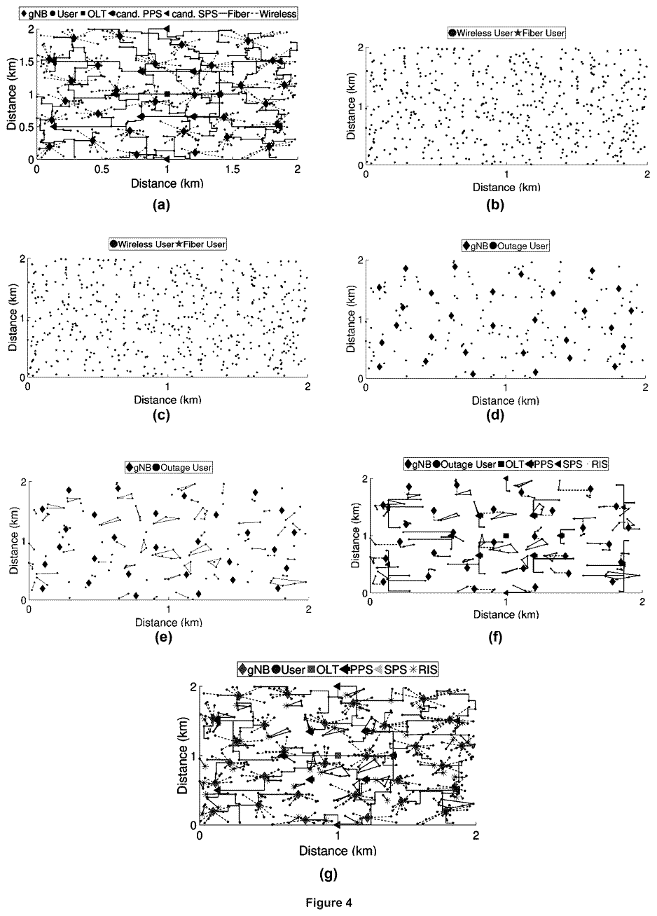

FIG. 4 presents the distribution of users and the complete deployment of various network devices under scenarios with and without rain loss. Specifically, FIG. 4(a) illustrates the network planning with fiber and wireless connections, along with other network devices, in the absence of rain loss. FIG. 4(b) shows the distribution of wireless and fiber-connected users. FIG. 4(c) highlights the increase in fiber-connected users when rain loss (150 mm/hr) is considered. This increase occurs due to a rise in outage users, who are subsequently provided with fiber connections. FIG. 4(d) depicts the distribution of outage users across different gNBs, while FIG. 4(e) outlines the convex hull for outage users within different gNB sectors. FIG. 4(f) illustrates the optimized placement of RIS in gNB sectors based on the convex hull of outage users. Finally, FIG. 4(g) presents the complete deployment plan under rain loss (150 mm/hr) with RIS utilization to enhance network coverage.

In this work, we consider a deployment area of 2 km×2 km. The network configuration includes a maximum of 30 gNBs, each with three sectors. Each sector is served by a UPA configuration consisting of 16×16 antenna elements. The RIS, which serves users in outage regions, is equipped with 16×16 reflecting elements. The maximum transmit power of a gNB is set at 30 dBm. The deployment costs include $24,000 for an OLT line card, $70 for a power splitter (PS), and $42,000 per km for fiber deployment. The splitting ratio of the PS is 1:64. There are six candidate locations each for primary power splitters (PPS) and secondary power splitters (SPS). The signal propagation is modeled using the Rural Macro (RMa) scenario to capture the characteristics of rural environments effectively.

Advantages of the described invention can be summarized as hereunder:
1. Environmental Resilience: The proposed system mitigates impairments like rain in a flexible manner, ensuring reliable mmWave communication under varying conditions.
2. Cost Efficiency: The convex hull-based RIS placement process minimizes infrastructure cost by optimizing RIS deployment for both new (greenfield) network planning and upgradation scenarios.
3. Enhanced Coverage: Active RIS deployment amplifies and redirects signals to outage-prone users, reducing outages and improving overall network performance.
4. Hybrid System Architecture: Combines FTTH technology, FWA technology, and RIS into a unified system solution, offering high Quality of Service (QoS) for both fiber and wireless users.
5. Scalability: The modular architecture supports diverse deployment and upgradation scenarios, making the solution adaptable to rural, suburban, and urban areas.

This invention is a scalable, cost-efficient, and resilient framework that supports both the deployment of new (greenfield) FiWi networks and the seamless upgradation of existing FiWi networks.

1. A system for Reconfigurable Intelligent Surfaces (RIS) assisted environmental impairment-aware robust cost-efficient Fiber-Wireless (FiWi) network planning and upgradation which mitigates signal loss caused by the environmental impairments including rain attenuation, wherein the said system comprises
at least one prediction module to forecasts the environmental impairments that degrade the signal quality;
at least one outage computation module fed with output of the prediction module to identify the outage regions based on environmental conditions and channel impairments, wherein the said outage computation module analyzes user locations and channel conditions including Signal-to-Interference-plus-Noise Ratio (SINR) to detect users in the outage regions; and
at least one RIS placement module which is configured to execute convex hull-based RIS placement determination based on the identified outage regions and the users located therein for dynamically determining candidate locations for the RIS deployment and optimizing the RIS placement for reflecting and amplifying the signals to serve outage users efficiently addressing coverage gaps.

2. The system as claimed in claim 1, wherein the outage computation module considers user-specific requirements, including data rate demands and geographical distribution, to identify weak coverage areas and the outage regions.

3. The system as claimed in claim 1, wherein the modules are scalable and deployed at various levels of the network, including Base Station (BS), edge servers, or cloud servers, depending on processing requirements and deployment scenario.

4. The system as claimed in claim 1, wherein the modules are implemented in computing and storage infrastructure on the network hardware.

5. The system as claimed in claim 1, wherein the FiWi network based on a multistage time-division multiplexing passive optical network (TDM-PON) having power splitter (PS) stages alongside gNBs includes
an Optical Line Terminal (OLT) located at central office;
a primary power splitter (PPS) connected to said OLT;
multiple secondary power splitters (SPSs) connected to the PPS for distributing optical signal further across the network;
at least an Optical Network Unit (ONU) at user end to serve an FTTH user, providing the user with fiber-based connectivity, and also optionally connected to the gNB through a hybrid module (ONU-gNB), allowing the ONU to provide backhaul for wireless services and serving as FWA users, whereby the FWA users are served through a Customer Premises Equipment (CPE) installed at the wireless user's location; and
said active RIS which are selectively deployed to enhance coverage of the wireless services by reflecting and amplifying the signals to the outage users for mitigating signal loss caused by the environmental impairments and ensures robust connectivity in challenging conditions.

6. A method for Reconfigurable Intelligent Surfaces (RIS) assisted environmental impairment-aware robust cost-efficient Fiber-Wireless (FiWi) network planning and upgradation which mitigates signal loss caused by the environmental impairments, wherein the said method comprises
receiving essential network related inputs, including user distribution, maximum number of gNBs that can be deployed, and network configurations for clustering and initial network planning;
grouping users of the network into clusters and placing at least one of the gNBs at centroids of these clusters, such as that the users are assigned to specific gNB sectors based on their geographical location, ensuring balanced load distribution across sectors;
dividing each gNB's coverage area into three non-overlapping sectors of 120°, served by dedicated Uniform Planar Array (UPA), thereby enabling efficient spatial multiplexing through dedicated UPAs;
framing wireless connections of the network through beamforming and channel parameter computation;
optimizing the wireless connections and network scenario without the environmental impairments;
optimizing the wireless connections and network scenario with the environmental impairments;
identifying outage users in the network for the environmental impairments and accordingly determining the candidate locations for RIS to serve the outage users;
optimizing the RIS placement and establishing the connections therewith to serve the outage users efficiently addressing coverage gaps for the the environmental impairments.

7. The method as claimed in claim 6, wherein the grouping users of the network into clusters is validated by Calinski-Harabasz (CH) criterion to ensure an efficient initial network layout that minimizes interference and maximizes coverage.

8. The method as claimed in claim 6, wherein the framing of the wireless connections builds foundational parameters for SINR and resource block computation and it includes
computing beamforming vectors (W_{c}^{Nb}) for each gNB sector, generating N_{b} simultaneous beams to enhance spatial multiplexing, whereby directional gain (G(θ, φ)) of the related UPA is calculated to optimize signal strength within each 120° sector;
calculating large-scale (path loss) and small-scale (multipath fading) channel parameters for signal frequencies preferably mm-Wave frequencies, whereby the gNB-user channel matrix (h_{gu}) is derived to quantify the quality of the link between the gNB and users.

9. The method as claimed in claim 6, wherein the optimization of the wireless connections and network scenario without the environmental impairments such as Rain Losses includes
computing SINR (Γ) using channel parameters (h_{gu}), gNB transmitted power, and beamforming gains to assesses the link quality for each user in their assigned sector, whereby based on the SINR, appropriate Modulation and Coding Scheme (MCS) class is selected and further based on the MCS value, the number of Resource blocks (RBs) required to meet the user's data rate is calculated;
involving an Integer Linear Programming (ILP) model which optimizes allocation of fiber and wireless connections for users, minimizing costs and ensuring connectivity, whereby model outputs include the fiber connections (Fᵤᵢ) and the wireless connections (Wᵤᵢ).

10. The method as claimed in claim 9, wherein the optimization of the wireless connections and network scenario with the environmental impairments such as Rain Losses includes
computing adjusted SINR (Γ) values considering environmental losses and further recalculating the MCS class and RB requirements accordingly;
involving ILP model for optimizing the Fiber and wireless connections under these modified conditions, producing outputs \hat{F}ᵤᵢ and Ŵᵤᵢ.

11. The method as claimed in claim 6, wherein the outage users are identified as those users (Oᵤ) who were initially provided with wireless connections in the ILP output computed without considering environmental losses and were subsequently assigned fiber connections in the ILP output when environmental losses (e.g., rain) were included in the optimization process.

12. The method as claimed in claim 6, wherein the determination of the candidate locations for deploying the RIS based on the outage users through convex hull process including
determining the outage users, whereby for each gNB and its sectors, users experiencing outages due to environmental impacts (e.g., rain attenuation) are identified;
computing convex hull, whereby for each sector with outage users, the convex hull that encloses all these users are computed;
identifying candidate locations, whereby vertices of the convex hull are identified as the candidate locations for deploying the RIS;
optimizing the RIS placement, whereby all the gNBs in the network are considered and the ILP is utilized to select the optimal RIS deployment locations from the identified candidate locations, the ILP is modeled to minimize capital expenditure while ensuring the data rate requirements of all users are satisfied.

13. The method as claimed in claim 12, wherein the optimization of the candidate RIS location includes
computing gNB-RIS channel matrix (H_{gr}) and RIS-user channel vector (hᵣᵤ) for each candidate RIS location to characterize indirect paths facilitated by the RIS, enabling SINR enhancements for outage users;
recomputing the SINR (Γ) for each outage user using the gNB-RIS channel matrix (H_{gr}) and the RIS-user channel vector (hᵣᵤ), considering indirect (gNB-RIS-user) paths;
recalculating the MCS and the required number of RBs based on the recomputed SINR, they are recalculated.

14. The method as claimed in claim 13, includes
involving the ILP optimization for the RIS-assisted wireless connections for outage users and replacing the previous ILP model output with environment impact;
reevaluating the users previously assigned with fiber connections under the environment impact and if the outage users are supported by the RIS-assisted wireless connections, these users are transitioned back to wireless connectivity, while existing wireless and fiber connections for non-outage users remain unchanged, maintaining consistency in the broader network design;
applying Minimum Spanning Tree (MST) to finalize the fiber layout, minimizing the trenching and duct cost.
